(19) United States
(12) Patent Application Publication
(10) Pub. No.: US 2026/0263306 A1
(43) Pub. Date: Sep. 10, 2026

(54) TRANSFER SUPPORT SYSTEM AND APPARATUS FOR ARTICULATING EXAMINATION CHAIRS AND TABLES

(71) Applicants: Bradley Hal Baker, Cottonwood Heights, UT (US); Joshua Vernon Christensen, Saratogo Springs, UT (US)

(72) Inventors: Bradley Hal Baker, Cottonwood Heights, UT (US); Joshua Vernon Christensen, Saratogo Springs, UT (US)

(21) Appl. No.: 19/072,974

(22) Filed: Mar. 6, 2025

(51) Int. Cl. A61G 13/12

(52) U.S. Cl. CPC A61G 13/1235

(57) ABSTRACT

A transfer support assembly adapted for attachment to an examination chair or table by using a receiver of the examination chair or table configured to receive removable armrests.

### BACKGROUND OF THE INVENTION

### 1. Field of the Invention

The present disclosure relates generally to examination chairs and table having one or more support surfaces to receive a patient during an examination or medical procedure. More particularly, the invention of this disclosure is directed to a transfer support system attached to the examination chair or table and to be grasped by a person to support and/or stabilize the person as the patient transfers or moves onto or leaves the chair or table. One or more embodiments of the present invention are directed to the structure of the transfer support including structure for selectively attaching and detaching the transfer support to the chair or table at any time when the chair or table is in a reclined, upright position or any position between reclined and upright. One or more preferred embodiments comprise a transfer support whose structure and placement comply with current ADA regulations.

### 3. Background and Related Art

Transfer support devices, sometimes described or referred to as grab bars, have been constructed in many different configurations and out of a number of materials. Transfer support devices are often placed or mounted in or near restrooms, toilets, showers or other locations to provide the user with a secure graspable structure. The transfer supports functions to bear support up to the person's body weight or part of it, or to steady the person as the person transfers from one location to another location such as when the person moves onto or into and subsequently exits toilets, showers, beds, other furniture, vehicles or rooms.

For ADA compliance, a transfer support must satisfy specified location, length, height, cross section, surface hazard, gripping surface, clearance and fitting regulations. Consistent with ADA guidelines, transfer support devices can be constructed in many different forms and mounted or secured in many ways.

More particularly related to medical examination chairs or tables, an ADA compliant transfer support used in connection with the examination chair or table must satisfy ADA regulations, currently published as 36 CFR part 1195 Appendix M305 Supports. For purposes of this application the term “ADA compliant transfer support” shall mean a transfer support which satisfies the requirements of 36 CFR part 1195 Appendix M305 Supports, or subsequent revisions. To that end, 36 CFR part 1195 Appendix M305 Supports and its successor or replacement regulation(s) are incorporated herein by express reference.

For purposes of this application, the term “chair” or “examination chair” will be used to refer to an examination chair, or to an examination table, or to them both collectively.

An examination chair may have one or more support surfaces such as a seat, back rest, leg rest or support, footrest or support, one or more arm rests and a head rest. The arm rests on some chairs are removable. Many examination chairs have lifting mechanisms to raise and lower the seat to specified, designated or required heights. Many chair permits one or more support surfaces to move or articulate, such as to rotate or extend relative to another support surface, such as positioning the support surfaces to provide an upright or sitting position, or positioning the chair into an inclined or substantially horizontal position.

Articulated examination and treatment chairs are used to position a patient in any of a variety of different positions that may be selected in accordance with a particular procedure being performed and with reference to the preferences of the particular operator or doctor.

Transfer support devices have been attached to an examination chair. One known way is to mount the transfer support to the underlying the frame of the chair as depicted in U.S. Pat. No. 9,038,216. The grab bars 38 are configured to be rotated between the first position and the second position while remaining coupled to the second base 34.

Thus, while various forms of transfer support systems exist challenges still persist. Accordingly, it would be an improvement in the art to provide a transfer support system which can be selectively attached to and released from the chair at a location conducive to patient comfort and safety and to provider convenience and ease of use and adjustment.

### SUMMARY OF THE INVENTION

The present invention relates generally to articulated chairs and, more specifically, to an articulated chair incorporating a receiver on one or both sides of the seat back used to receive a removable arm rest. In particular, embodiments of the present invention relate to a new transfer support system adapted for insertion into the arm rest receiver for ready attachment to and removal from the chair.

Implementations of the present invention may take place in association with an articulated chair having multiple hingedly coupled sections, such as a seat, and leg rest section or a separate leg rest section, and a backrest section. In some implementations, the articulated chair further includes a base having means for raising and lowering the seat, and other means for moving sections of the chair into desired configurations, such as into a reclined position, an upright position, and a semi-reclined position.

An articulated chair in accordance with the present invention further includes an apparatus and system to removably receive and release an arm rest on the side of the chair. That is, an armrest having an arm rest adapter assembly is coupled to a portion of the chair back by inserting the arm rest adapter assembly in a receiver disposed in the chair back.

In embodiments of the present invention, the receiver used to host the armrest is alternatively used to host a transfer support device thus providing a novel transfer support system utilizing existing elements of an articulated examination chair. This results not only in savings for construction and implementation of a transfer support system, but it also disposes the transfer support at a location helpful to the patient and convenient for manipulation by the health providers.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWING

In order that the manner in which the above recited and other features and advantages of the present invention are obtained, a more particular description of the invention will be rendered by reference to specific embodiments thereof, at least one of which is illustrated in the appended drawing. Understanding that the drawing depicts only typical embodiments of the present invention and is not, therefore, to be considered as limiting the scope of the invention, the present invention will be described and explained with additional specificity and detail through the use of the accompanying drawing in which:

FIG. 1 is a perspective view of a transfer support system in accordance with a representative embodiment of the present invention;

FIG. 2A is a perspective view of an articulated chair demonstrating a transfer support system in accordance with a representative embodiment of the present invention;

FIG. 2B is a front view of a transfer support system in accordance with a representative embodiment of the present invention;

FIG. 2C is a front perspective side view of a transfer support system in accordance with a representative embodiment of the present invention;

FIG. 3 is a front view of a transfer support attached to an articulated chair in an upright position in accordance with a representative embodiment of the present invention;

FIG. 4A is a perspective view of a transfer support in a first position attached to an articulated chair position in accordance with a representative embodiment of the present invention;

FIG. 4B is a perspective view of a transfer support in a second position attached to an articulated chair position in accordance with a representative embodiment of the present invention;

FIG. 4C is a perspective view of a transfer support in a third position attached to an articulated chair position in accordance with a representative embodiment of the present invention;

FIG. 4D is a perspective view of a transfer support in a fourth position attached to an articulated chair position in accordance with a representative embodiment of the present invention;

FIG. 5A is a perspective view of a transfer support system in accordance with a representative embodiment of the present invention;

FIG. 5B is a front view of a transfer support system in accordance with a representative embodiment of the present invention;

FIG. 6A is a front view of a transfer support attached to an articulated chair in an upright position in accordance with a representative embodiment of the present invention;

FIG. 6B is a front perspective view of a transfer support attached to an articulated chair in an upright position in accordance with a representative embodiment of the present invention; and

FIG. 7 is a rear perspective view of a transfer support system in accordance with a representative embodiment of the present invention.

### DETAILED DESCRIPTION OF THE INVENTION

The present invention relates generally to articulated chairs and, more specifically, to an articulated chair incorporating a transfer support system. In particular, at least some embodiments of the present invention relate to a transfer support system comprising a transfer support device selectively and removably attached to the side of the chair, and more particularly that the transfer support device is received into the side of the back of the chair into a receiver alternatively used to position an armrest to the chair.

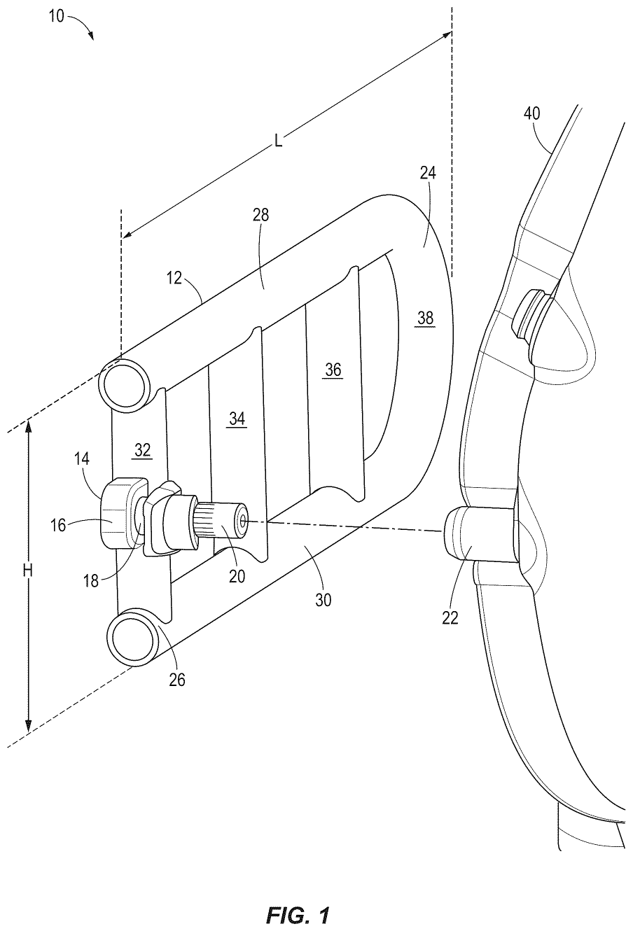

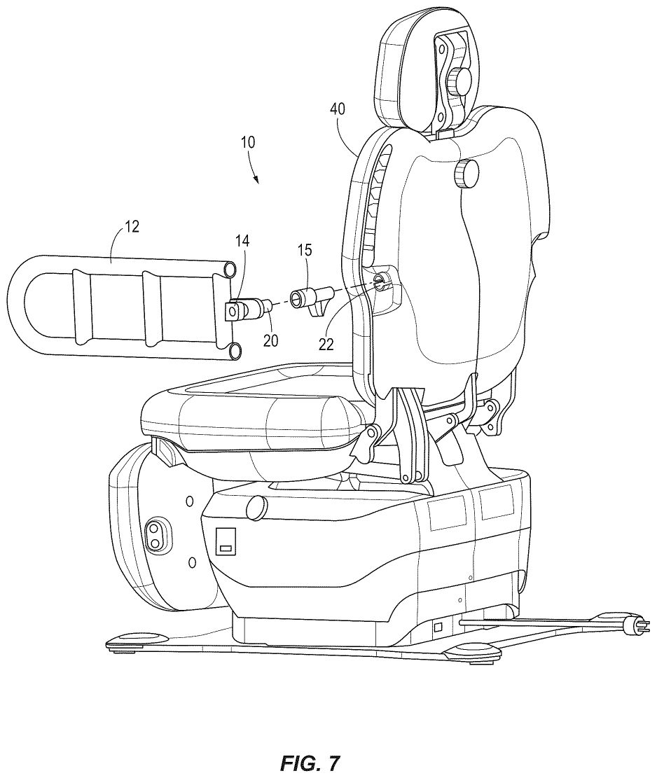

Examination chairs typically include, generally, a seat, a back rest, a head rest and arm rests. Some chairs are configured to have removable arm rests. Removable arm rests may be attached to the chair back by configuring a receiver into the chair back into which a portion of the arm rest is inserted. Each chair in FIGS. 1-7 is configured to include removable arm rests inserted into a receiver 22. For purposes of the present invention the arm rests have been removed from receiver 22.

Referring to FIG. 1, one embodiment of a transfer support system 10 is shown. System 10 comprises a transfer support assembly comprising transfer support 12, a transfer support adapter 14 and receiver 22 of seat back 40. As shown in FIG. 1, transfer support 12 may comprise a length L with a first end 24 and a second end 26 and comprising a height H. Support 12 may further comprise a first horizontal member 28 and a second horizontal member 30 with a plurality of vertical members 32, 34, 36, and 38. Members 28, 30, 32, 34, 36, and 38 joined together form a rigid transfer support 12 and can be used as grasp bars.

For current ADA compliance, circular grasp bars such as members 28 and 30 of transfer support 12 must have outside diameter between 1.25 and 2.0 inches for ease of grasping, be at least 15 inches in length L, be free of sharp or abrasive components and be continuous on the top and sides, be at least 1.5 inches from any adjacent surface. Support 12 must not rotate in its fitting when in place for transfer. 36 CFR part 1195, Appendix to Part 1195 Chapter 3 Technical Requirement M305 (“ADA Compliant”). To meet these ADA requirements transfer support 12 may be constructed of any suitable material so long as the ADA Requirements are met. Stainless steel is a preferred construction material. For ongoing ADA Compliance, 36 CFR part 1195, Appendix to Part 1195 Chapter 3 Technical Requirement M305 is incorporated herein by express reference.

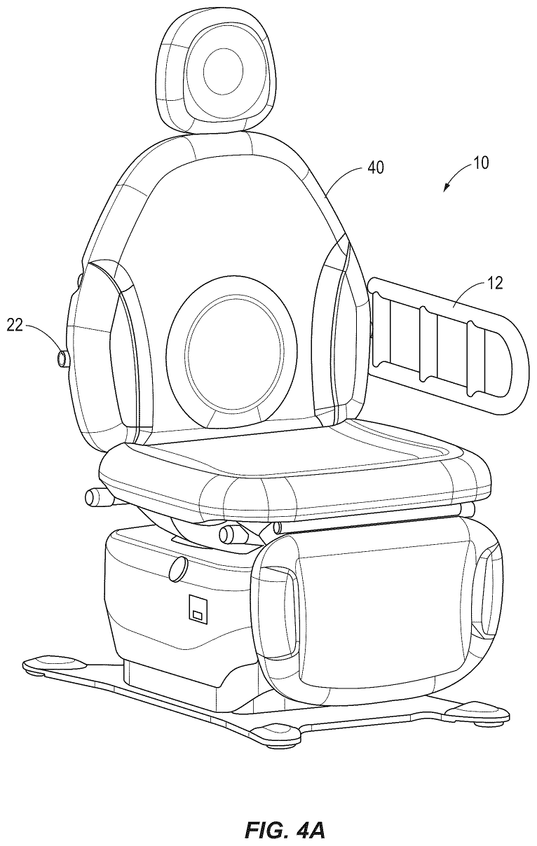

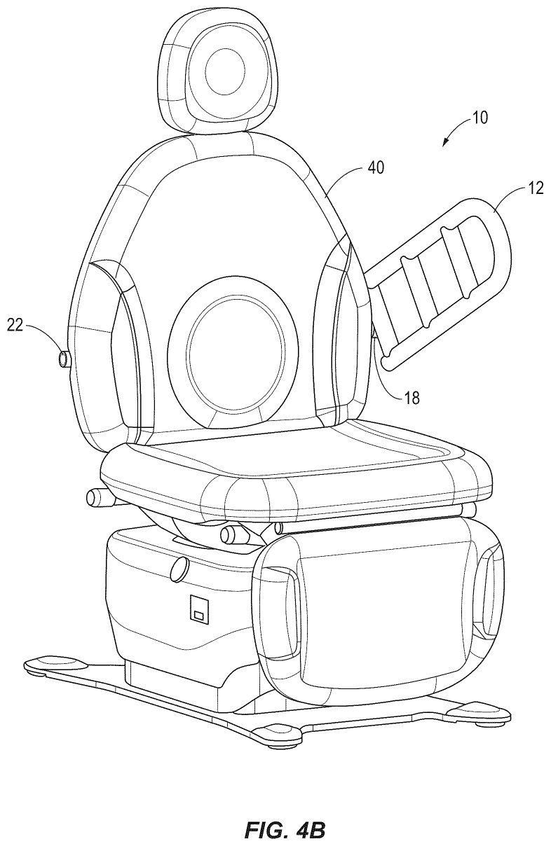

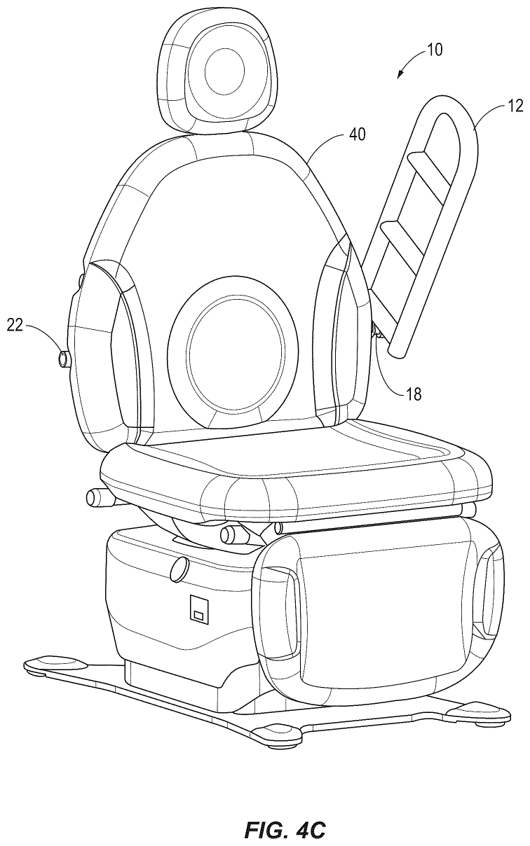

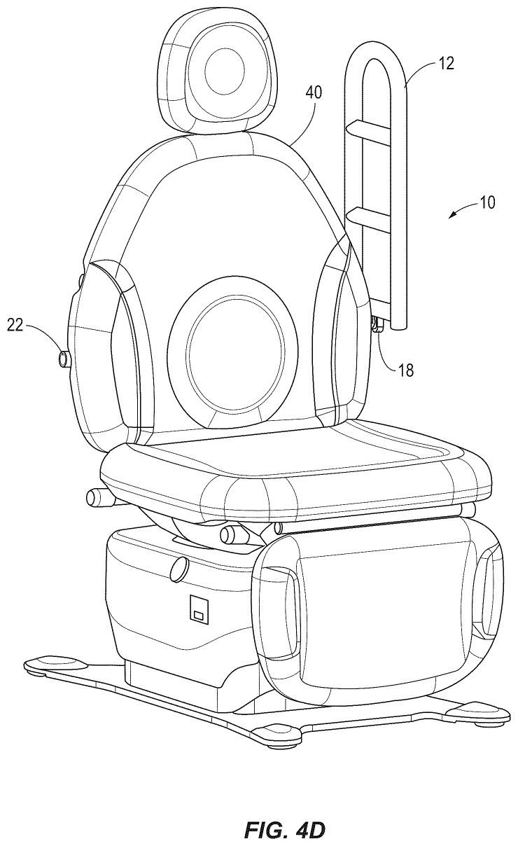

Transfer support adapter 14 provides structure and function to fixedly and removably attach support 12 to chair back 40. Adapter 14 comprises a mount 16. Mount 16 attaches adapter 14 to support 12. Adapter 14 also includes a swivel 18. Swivel 18 permits support 12 to rotate about swivel 18 as shown in FIGS. 4A-4B. Adapter 14 also includes insert 20.

Insert 20 is inserted into receiver 22 of chair back 40. The exterior surface of insert 20 and the interior surface of receiver 22 may comprise any combination of mating or otherwise interacting or interfacing surfaces or members to facilitate insert 20 being fixedly retained in receiver 22 and also being, by manual manipulation or otherwise, selectively and removably released from receiver 22. The structure and function of insert 20 and receiver 22 achieve compatibility, interlocking and release between insert 20 and receiver 22. This compatibility, interlocking and release between insert 20 and receiver 22 shall be defined in this application as means for selectively attaching insert 20 of transfer support 12 to and releasing insert 20 of support 12 from receiver 22 of seat back 40. Adapter 14 may be constructed of any suitable material to achieve its function, stainless steel is the preferred construction material.

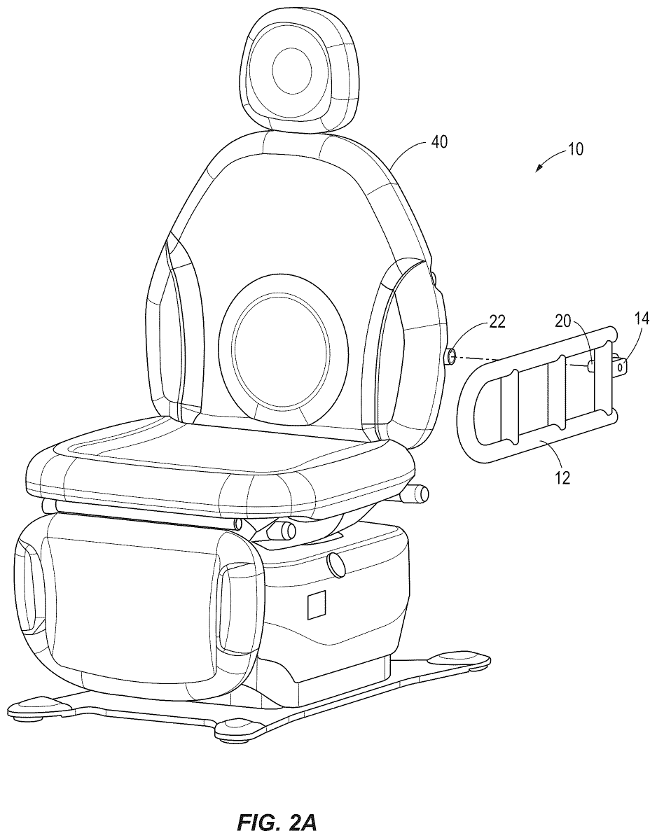

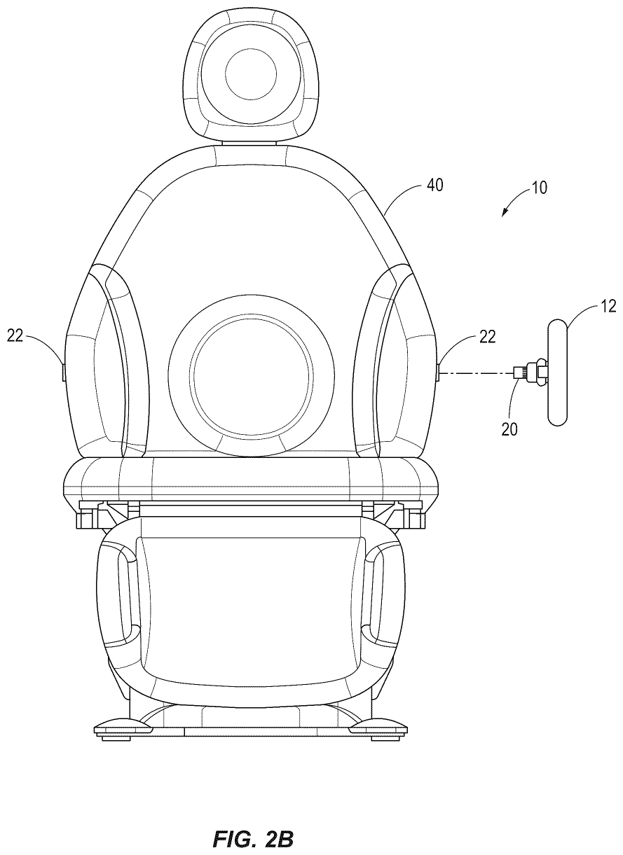

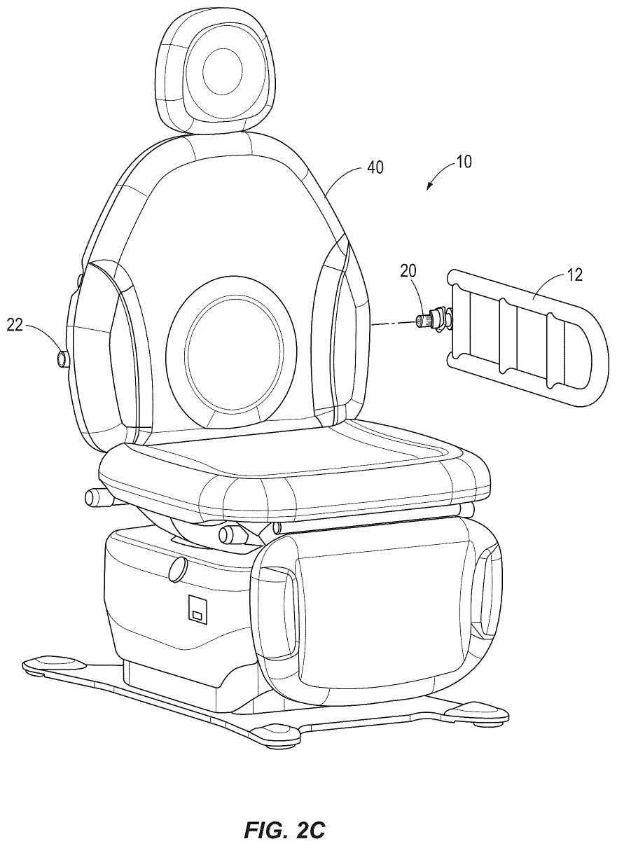

As shown in all Figures, receiver 22 is mounted on in or on chair back 40. A similar receiver 22 is also mounted on the other side of chair back 40. FIGS. 2A-C illustrate that insert 20 of adapter 14 is to be inserted into receiver 22 on a first side of the chair. FIGS. 2B and 2C disclose that a second receiver 22 may be disposed on a second side of chair back 40.

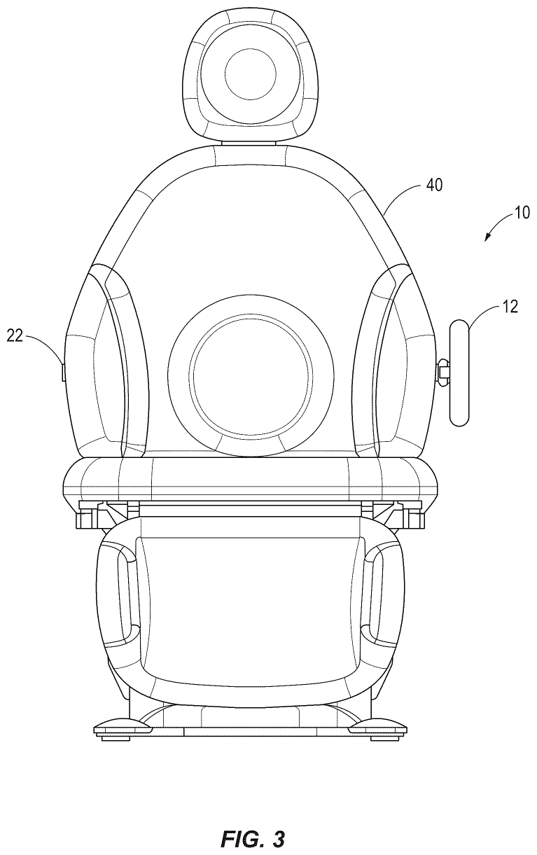

FIG. 3 depicts support 12 attached to chair back 40.

As shown in FIGS. 4A-4C, swivel 18 permits support 12 to rotate about swivel 18 as desired or needed. This rotation permits ease of entry of a patient into the chair and convenience to health providers if the health providers need or desire to move support 12 to different positions.

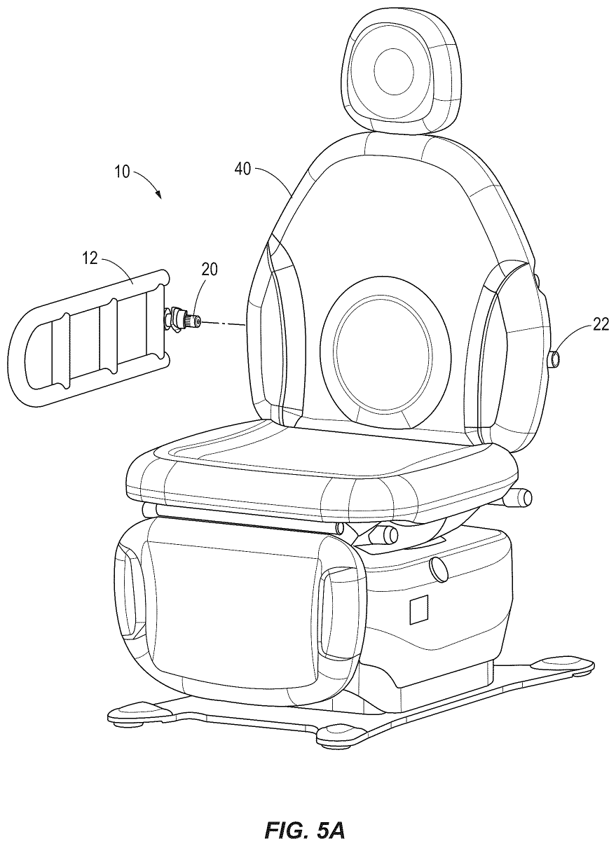

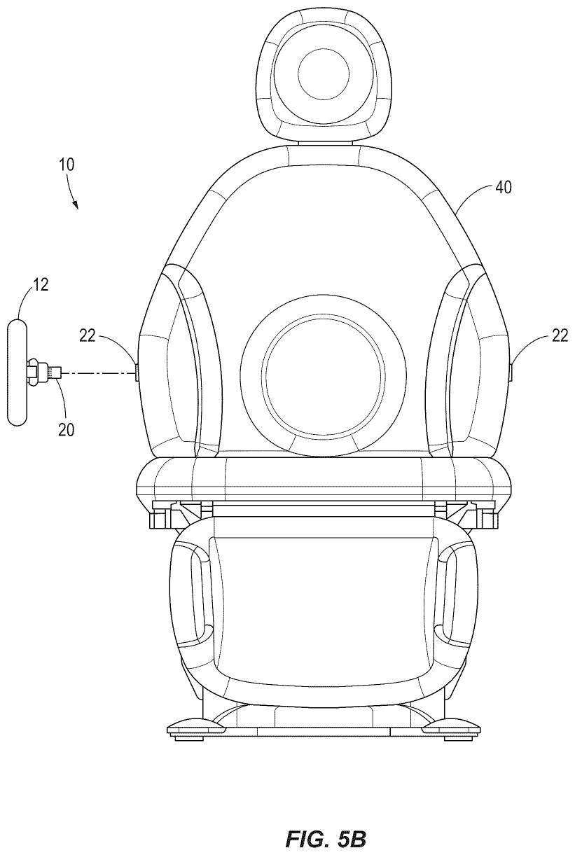

FIGS. 5A and 5B depicts the same support 12 positioned for insertion into another receiver 22 on or in the second side of chair back 40.

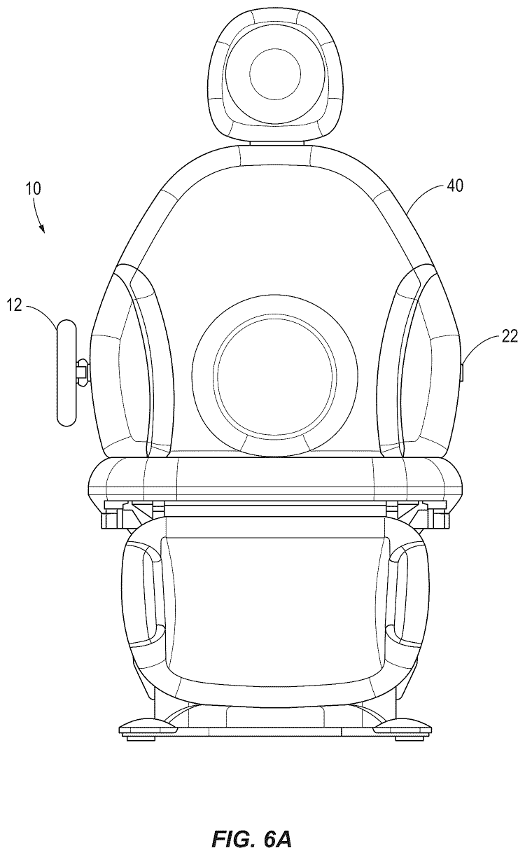

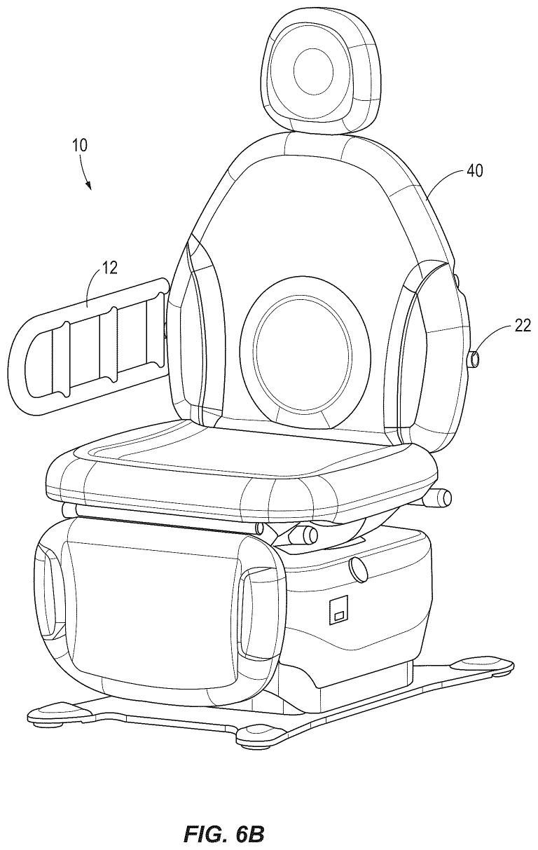

FIGS. 6A and 6B depict support 12 attached to the second side of chair back 40.

When insert 20 of adapter 14 is not compatible with receiver 22, an intermediate insert adapter 15 may be placed between insert 20 and receiver 22. That is, insert 20 is coupled to insert adapter 15 and insert adapter 15 is inserted into receiver 22. The exterior surface of insert adapter 15 and the interior surface of receiver 22 may comprise any combination of mating or otherwise interacting or interfacing surfaces or members to facilitate insert adapter 15 being fixedly retained in receiver 22 and also being, by manual manipulation or otherwise, selectively and removably released from receiver 22. Insert adapter 15 may be constructed of any suitable material to achieve its function, stainless steel is the preferred construction material.

In use, a removable arm rest is removed from receiver 22, not shown. Transfer support 12 is then attached to the chair at receiver 22. Support 21 may be lowered or rotated to a horizontal position when a patient approaches the examination chair. The patient may grasp support 12 to transfer weight or otherwise provide stability to the patient as the patient approaches the examination chair and as the patient transfers onto or off of the seat of the chair.

The articulated chair can have many other functions and operations. Incorporated herein by express reference is the disclosure of U.S. Pat. No. 9,782,319. It provides disclosure of an articulating chair disclosing selectively and removable arm rest assemblies attached to and released from the back of a chair (wherein element 92 and 108 of arm rest adapter 90 are inserted into receiver 86). It also provides exemplary disclosures of structure and function for compatibility, interlocking and release between an insert such as insert 20 and a receiver such as receiver 22, thus providing structure and function for the means for selectively attaching transfer support 12 to and releasing support 12 from seat back 40 of this application. U.S. Pat. No. 9,782,319 also discloses exemplary lift mechanisms to raise the lower the chair to the transfers surfaces and the transfer support system are at the ADA required height.

The described chair is an examination apparatus. Other examination apparatuses can include examination tables and any other examination structure on which or against which a patient by be disposed during an examination or procedure.

Thus, as discussed herein, the embodiments of the present invention generally relate to positionable or articulated chairs and, more specifically, to an articulated chair incorporating an transfer support system. In particular, embodiments of the present invention relate to a transfer support system adapted for selective attachment and removal from the examination chair using a pre-existing receiver also used to host removable arm rests.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the function and structure of the disclosure and claims are to be embraced within their scope.

What is claimed is:

1. A transfer support system used in connection with an examination apparatus such as a chair or table, the transfer support system comprising:
an examination apparatus comprising a backrest having receivers;
a transfer support assembly comprising an insert member configured to be received into the receiver; and
means for selectively attaching the transfer support assembly to and releasing the transfer support assembly from the receiver.

2. The system of claim 1 wherein the transfer support assembly further comprises a transfer support device comprising one or more grasp bars, a transfer support adapter attached to at least one grasp bar for selectively attaching the transfer support assembly to and releasing the transfer support assembly from the receiver.

3. The system of claim 2 wherein the transfer support adapter comprises a mount for attaching the transfer support adapter to the transfer support device, and an insert for insertion into the receiver, wherein an exterior surface of the insert and an interior surface of receiver comprise a combination of interacting members providing means for selectively attaching the insert into and releasing the insert from the receiver.

4. The system of claim 2 wherein the transfer support assembly is ADA compliant.

5. The system of claim 2 wherein the transfer support adapter further comprises a swivel to permit the transfer support device to rotate about the transfer support adapter.

6. The system of claim 3, further comprising and an insert adapter insert place between the insert and the receiver, wherein the insert is coupled to the insert adapter and the insert adapter is inserted into receiver.

7. The system of claim 6 wherein the exterior surface of the insert adapter and the interior surface of the receiver comprise a combination of interacting members to facilitate to retain the insert adapter in the receiver.

8. A transfer support assembly used in connection with an examination apparatus having one or more receivers to receiver removable arm rests, the transfer support assembly comprising:
a transfer support device comprising one or more grasp bars;
a transfer support adapter attached to at least one grasp bar; and
means for selectively attaching the transfer support device to and releasing the transfer support device from a receiver of an examination apparatus.

9. The transfer support assembly of claim 8 wherein the transfer support device comprises one or more horizontal members.

10. The transfer support assembly of claim 8 wherein the transfer support device comprises one or more vertical members.

11. The transfer support assembly of claim 8 wherein the transfer support device comprises one or more horizontal members and one or more vertical member.

12. The transfer support assembly of claim 8 wherein the transfer support device comprises a looped member providing a horizontal or vertical grasp bar.

13. The system of claim 8 wherein the transfer support adapter comprises a mount for attaching the transfer support adapter to the transfer support device, and an insert for insertion into the receiver, wherein an exterior surface of the insert and an interior surface of receiver comprise a combination of interacting members providing means for selectively attaching the insert into and releasing the insert from the receiver.

14. The system of claim 8 wherein the transfer support assembly is ADA compliant.

15. The system of claim 8 wherein the transfer support adapter further comprises a swivel to permit the transfer support device to rotate about the transfer support adapter.

16. The system of claim 13, further comprising an insert adapter, the insert adapter placed between the insert and the receiver, wherein the insert is coupled to the insert adapter and the insert adapter is inserted into receiver.

17. The system of claim 16 wherein the exterior surface of the insert adapter and the interior surface of the receiver comprise a combination of interacting members to retain the insert adapter in the receiver.
